(19) United States
(12) Patent Application Publication
(10) Pub. No.: US 2014/0077491 A1
(43) Pub. Date: Mar. 20, 2014

(54) Branching Apparatus for Branching Pipes

(71) Applicants: Byoung Yong Jung, Goyang-Si (KR); Michael Troy Deason, Birmingham, AL (US); Young Suk Sin, Daejeon (KR); Bradley Robert Kokoski, Fort Mill, SC (US)

(72) Inventors: Byoung Yong Jung, Goyang-Si (KR); Michael Troy Deason, Birmingham, AL (US); Young Suk Sin, Daejeon (KR); Bradley Robert Kokoski, Fort Mill, SC (US)

(21) Appl. No.: 13/713,346

(22) Filed: Dec. 13, 2012

(30) Foreign Application Priority Data
Sep. 20, 2012 (KR) 10-2012-0104447

(51) Int. Cl. F16L 41/06

(52) U.S. Cl. CPC F16L 41/06
USPC 285/197

(57) ABSTRACT

The branching apparatus according to the present invention includes two power supply terminals mounted on a saddle in the opposite direction of a branch connection part branched from a cylindrical body, so that they are not overlapped with the branch connection part when an electric socket is connected to the power supply terminal, and hence, it provides easiness in work. Moreover, because the branch connection part is slantly mounted directly above the main pipe, a trace wire inserted into the branch connection part and the main pipe is not bent, and hence, the trace wire can trace exact length and position.

### REFERENCE TO RELATED APPLICATIONS

This application claims the priority benefit of Korean Patent Application No. 1 0-201 2-01 04447 filed on Sep. 20, 2012, the entire contents of which are incorporated herein by reference.

### FIELD OF THE INVENTION

The present invention relates to a branching apparatus for connecting a branch pipe from a main pipe in which a fluid flows or for installing auxiliary devices including a measuring device to the main pipe.

### BACKGROUND OF THE INVENTION

In order to repair a main pipe in which a fluid, such as gas, flows, to install branch pipes, or to install auxiliary devices, various kinds of branching apparatuses fused to the main pipe have been studied. Korean Patent Laid-open No. 2003-0084283 (entitled “Socket for plugging pipes and pipe branching apparatus using the same) (hereinafter, called a ‘prior art’) discloses a socket and a branching apparatus for conveniently connecting a branch pipe with a device for conveniently repairing a main pipe.

FIG. 1 is an exploded perspective view of the socket disclosed in the prior art, and FIG. 2 is a sectional view showing a structure of the branch pipe using the socket of FIG. 1.

The socket 100 illustrated in FIG. 1 includes a saddle member 150 for screw-coupling an upper saddle part 151 put on an upper portion of the main pipe 10 with a lower saddle part 152 supporting a lower portion of the main pipe 10; a body part 110 upwardly extending from the upper portion of the upper saddle part 151; a cover part 120 screw-coupled with the body part 110; and a shut-off part 140 mounted inside the body part 110 in a vertically movable manner.

A heat wire is mounted on a lower surface of the upper saddle part 151, and heat wire is fused on the main pipe 10 by receiving electricity from a power supply terminal 151 a mounted at right and left sides relative to the body part 110.

Such a socket 110 is generally installed in order to repair a leakage area of the main pipe 10, and is installed through the steps of: inserting a cutter (not shown) into the body part 110; cutting the leakage area and discharging the cutter; and joining the cover part 120.

Moreover, as shown in FIG. 2, the socket is utilized and used as a connection device 200 for connecting the branch pipe.

The connection device 200 illustrated in FIG. 2 has the same structure as the socket 100 illustrated in FIG. 1, but has a branch connection part 250 formed vertically on a body part 210, and a branch pipe not shown in the drawings is connected to the branch connection part 250.

In order to use the connection device 200, the connection device 200 is mounted on the main pipe 10, and then, electricity is supplied to the power supply terminal 151 a so that the upper saddle part 151 is fused to the main pipe 10. After that, a cover part 220 is separated and a cutter, which is not shown, is inserted into the body 210 in such a fashion that a round hole is formed in the main pipe 10. After the cutter is removed from the body part 210, the cover part 220 is joined to the body part 210. After that, when gas is re-supplied to the main pipe 10, gas is branched at the branch pipe through the branch connection part 250.

In the above structure of the connection device 200, in order to avoid a complicated work due to overlap of the branch connection part 250 and the power supply terminal 151 a when the branch connection part 250 is formed in the same direction as the main pipe 10, the branch connection part 250 is formed in a perpendicular direction to the main pipe 10.

A trace wire is inserted and mounted into the branch pipe connected to the branch connection part 250. The trace wire passing through the branch pipe is inserted into the main pipe 10 in order to trace lengths, installation positions, and others of the branch pipe and the main pipe 10. However, in the piping structure illustrated in FIG. 2, the trace wire is bent twice in order to be inserted into the main pipe 10 through the branch connection part 250, and hence, it is difficult that the trace wire exactly goes along the main pipe 10, or the trace wire may cause communication problems even though it is exactly inserted into the main pipe 10.

Moreover, as shown in FIG. 2, when the trace wire is bent vertically twice in a short flow passage where the main pipe 10 and the branch connection part 250 are connected, because a great resistance is formed in the flow passage, it causes a great loss of energy.

### SUMMARY OF THE INVENTION

Accordingly, the present invention has been made to solve the above-mentioned problems occurring in the prior arts, and it is an object of the present invention to provide a branching apparatus, which minimizes a loss of energy, which allows a trace wire to function as normal because the trace wire is installed easily without being bent if possible, and which is easily installed.

The branching apparatus according to the present invention includes two power supply terminals mounted on a saddle in the opposite direction of a branch connection part branched from a cylindrical body, so that they are not overlapped with the branch connection part when an electric socket is connected to the power supply terminal, and hence, it provides easiness in work. Moreover, because the branch connection part is slantly mounted directly above the main pipe, a trace wire inserted into the branch connection part and the main pipe is not bent, and hence, the trace wire can trace exact length and position.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view of a socket according to a prior art;

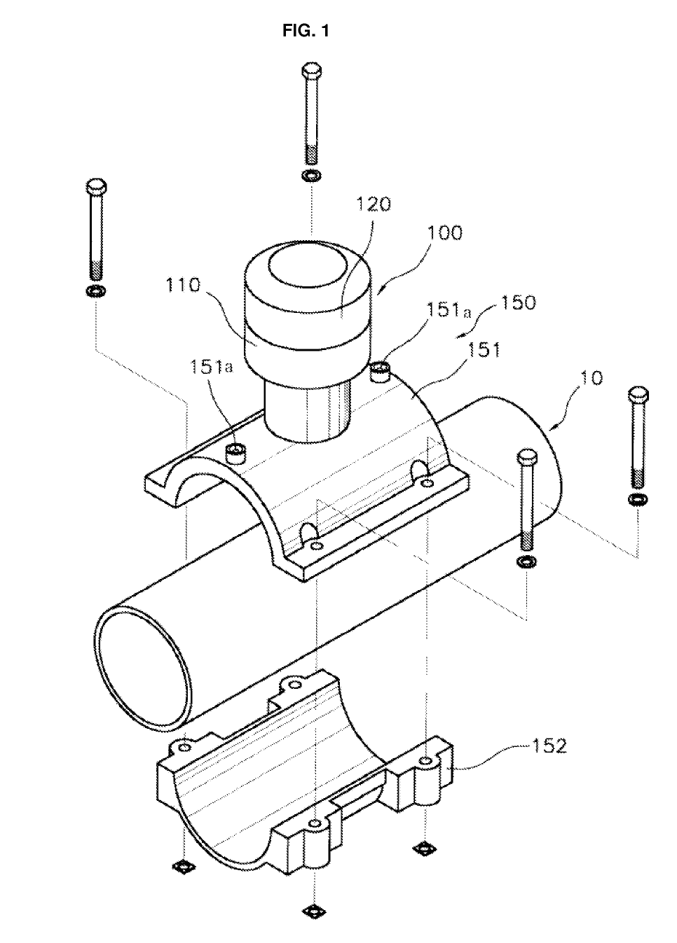

FIG. 2 is a sectional view showing a structure of a branch pipe using the socket of FIG. 1;

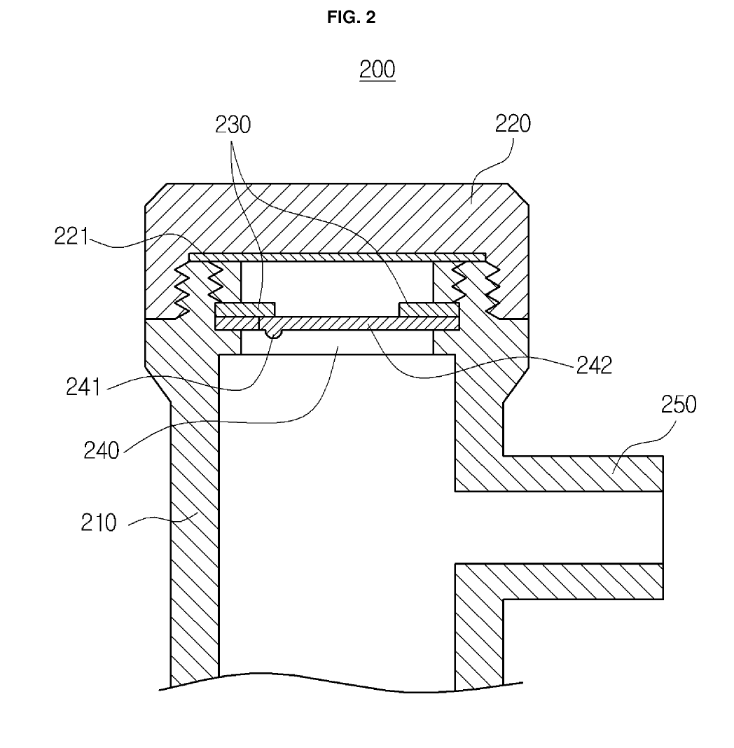

FIG. 3 is a sectional view showing an installation state of a branching apparatus according to the present invention; and

FIG. 4 is a perspective view showing a cover is not mounted on the branching apparatus according to the present invention.

### DETAILED DESCRIPTION OF THE INVENTION

Reference will be now made in detail to the preferred embodiment of the present invention with reference to the attached drawings.

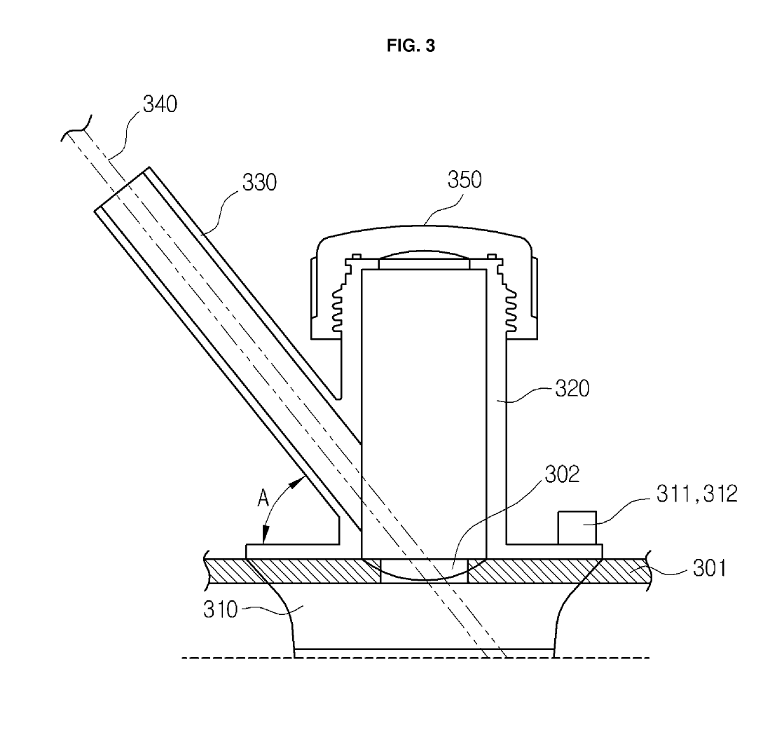

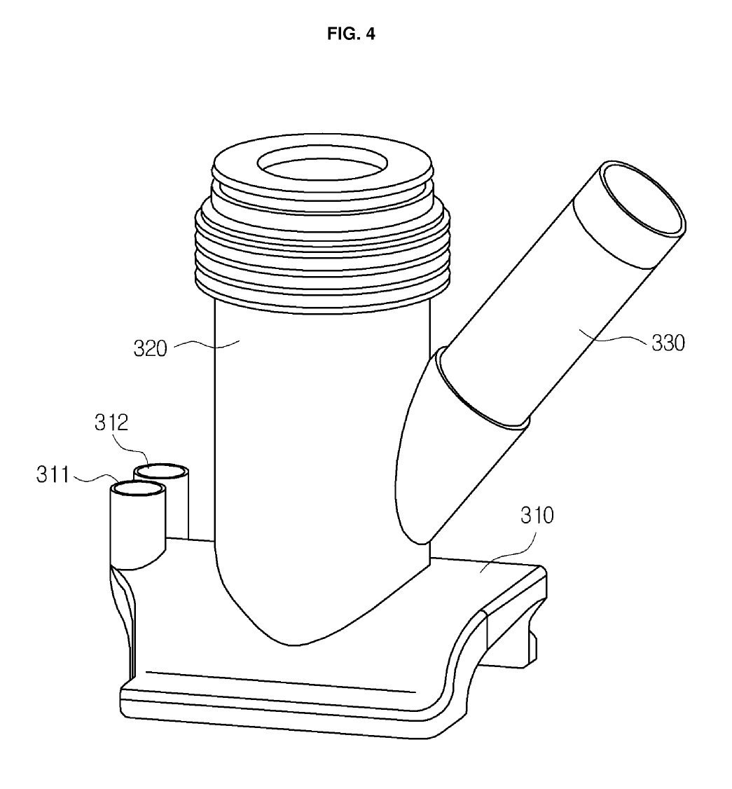

FIG. 3 is a sectional view showing an installation state of a branching apparatus according to the present invention, and FIG. 4 is a perspective view showing a cover is not mounted on the branching apparatus according to the present invention.

The branching apparatus 300 illustrated in FIGS. 3 and 4 includes: a saddle 310 fused on an upper surface of a main pipe 301 in which a fluid, preferably, gas flows; a cylindrical body 320 extending upwardly from the saddle 310 and having a hollow portion communicating with an opening 302 of the main pipe 301; and a branch connection part 330 slantly branched from the cylindrical body 320 and keeping an angle (A) to a center line(C) of the main pipe 301.

An electric heating wire is mounted in a lower face of the saddle 310. The electric heating wire is heated by electricity flowing through two power supply terminals 311 and 312, so that the lower face of the saddle 310 is fused and melted on the upper surface of the main pipe 301.

The two power supply terminals 311 and 312 are mounted on the upper face of the saddle 310, and in this instance, are all mounted at one side relative to the cylindrical body 320, namely, are all mounted in the opposite direction to the direction that the branch connection part 330 is branched from the cylindrical body 320.

As described above, when the branch connection part 330 is branched from the cylindrical body 320 in the opposite direction of the power supply terminals 311, 312 the electric socket is connected to the power supply terminals 311, 312 without being overlapped with the branch connection part 330.

In order to supply electricity to the electric heating wire of the saddle 310, the electric sockets must be connected to the power supply terminals 311, 312 but it is difficult to connect the electric sockets when the branch connection part 330 passes over the power supply terminals 311, 312. Accordingly, in the present invention, the branch connection part 330 is not mounted over the power supply terminals 311, 312.

Furthermore, the branch connection part 330 is branched from the lower part of the cylindrical body 320 and slantly mounted directly above the main pipe 301. In other words, when the branch connection part 330 is projected in a vertical direction, the mounted direction of the branch connection part 330 coincides with that of the main pipe 301, and hence, the trace wire can be inserted into the branch pipe connected to the branch connection part 330 without being bent.

Additionally, the branch connection part 330 is inclined and branched upwardly from the lower part of the cylindrical body 320, and in this instance, it is preferable that the inclination angle (A) formed between the center line of the branch connection part 330 and the center line(C) of the main pipe 301 is within a range of 50 degrees to 60 degrees.

In the case that the branch pipe (not shown) is connected to the branch connection part 330, the trace wire 340 for tracing a length, a position, and others of the branch pipe is mounted, and a control box for tracing the length and position of the branch pipe by sending a signal and receiving a reflected signal is mounted at a start end portion of the trace wire 340. In this instance, if the inclination angle (A) is less than 50 degrees, it causes problems in installation, for instance, it is difficult that the trace wire passes through the opening 302 of the main pipe 301 connected with the inside of the cylindrical body 320 and the trace wire is caught to a retaining portion formed between the opening 302 and the cylindrical body 320. If the inclination angle (A) exceeds 60 degrees, the trace wire 340 passing the branch connection part 330 forms a bent portion while being inserted into the main pipe 301, and hence, it is difficult to trace exact position and length because it is difficult to exactly send the signal.

Moreover, the cylindrical body 320 has a spiral thread formed on the outer circumferential surface of the upper part thereof, and a cap 350 having a spiral thread formed on the inner circumferential surface thereof is mounted on the outer circumferential surface of the upper part of the cylindrical body 320. As described above, because the cylindrical body 320 has the spiral thread formed on the outer circumferential surface, when the cap 350 is coupled to the cylindrical body 320, the inner diameter of the cylindrical body 320 is not reduced and a cutter can be easily inserted into the cylindrical body 320. Like the prior art, the cap 350 is separated from the cylindrical body 320 when the cutter is inserted into the cylindrical body 320 in order to form the opening 302 in the main pipe 301, and after work is ended, the cap 350 is coupled to the cylindrical body 320 to thereby prevent leakage of fluids, such as gas.

Furthermore, the saddle 310 is fixed at the main pipe 301 via a band, which is not shown in the drawings, or fastened by a lower seating part, which is not shown in the drawings, mounted at the main pipe and bolts and nuts.

Additionally, FIGS. 3 and 4 illustrate that the branch pipe is connected to an end portion of the branch connection part 330, but measuring devices for measuring measurements of the main pipe, such as a pressure gauge, may be mounted.

1. A branching apparatus for branch pipes, which includes: a saddle fused on an upper surface of a main pipe in which a fluid flows; a cylindrical body upwardly protruding from the saddle, communicating with an opening formed in the main pipe, and having a cap which is mounted on the top of the cylindrical body; and a cylindrical branch connection part branched from the cylindrical body, the branching apparatus comprising:
two power supply terminals mounted in an upper face of the saddle for supplying electricity to an electric heating wire mounted in the saddle, the power supply terminals being mounted in the opposite direction to a direction that the branch connection part is branched relative to the cylindrical body.

2. The branching apparatus according to claim 1, wherein the branch connection part is mounted directly above the main pipe and inclined at an inclination angle (A).

3. The branching apparatus according to claim 2, wherein the inclination angle (A) is within a range of 50 degrees to 60 degrees.

4. The branching apparatus according to claim 1, wherein a trace wire is inserted into the main pipe through the branch connection part.

5. The branching apparatus according to claim 1, wherein a branch pipe or a measuring device is connected to an end portion of the branch connection part.

6. The branching apparatus according to claim 1, wherein a cylindrical body has a spiral thread formed on the outer circumferential surface of the upper part thereof and a cap having a spiral thread formed on the inner circumferential surface thereof is mounted on the outer circumferential surface of the upper part of the cylindrical body.

7. The branching apparatus according to claim 2, wherein a trace wire is inserted into the main pipe through the branch connection part.

8. The branching apparatus according to claim 2, wherein a branch pipe or a measuring device is connected to an end portion of the branch connection part.

9. The branching apparatus according to claim 2, wherein a cylindrical body has a spiral thread formed on the outer circumferential surface of the upper part thereof and a cap having a spiral thread formed on the inner circumferential surface thereof is mounted on the outer circumferential surface of the upper part of the cylindrical body.
